(19) United States
(12) Patent Application Publication
(10) Pub. No.: US 2004/0191736 A1
(43) Pub. Date: Sep. 30, 2004

(54) Fire light and sound simulator for fire fighter training

(76) Inventor: Walter John Werhun, Edmond, OK (US)

Correspondence Address: Walter J. Werhun, 1820 Craig Blvd., Edmond, OK, 73003, US

(21) Appl. No.: 10/395,761

(22) Filed: Mar. 25, 2003

(51) Int. Cl. G09B 19/00

(52) U.S. Cl. 434/226

(57) ABSTRACT

A small mobile box, which simulates fire by producing a red or orange light, accompanied by sounds similar to that of a fire. Also integral to the device is a water activated shut-off switch. The device can be placed in a room of a structure, the room then filled with artificial smoke, and a fire fighter trainee can then search for the device in the structure. Once the device is found, the fire fighter can direct a hose stream onto the device, which will turn itself off.

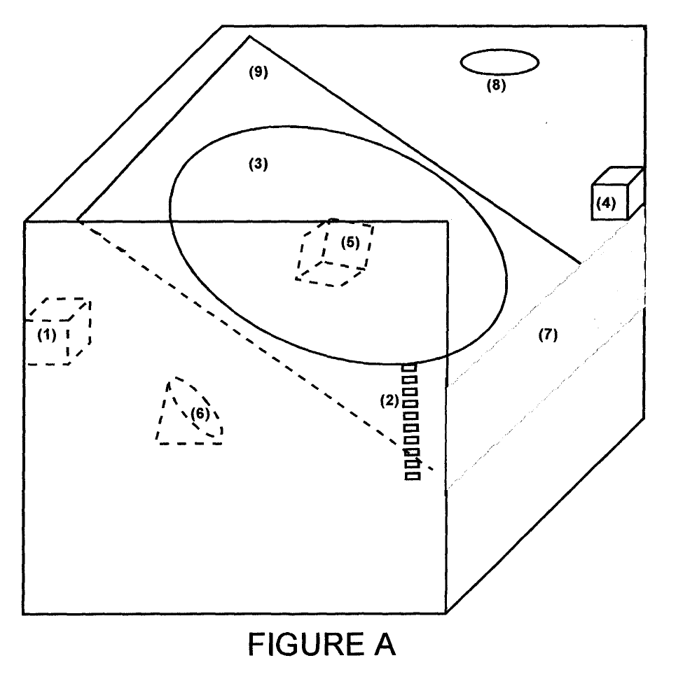

### BACKGROUND OF INVENTION

This invention can be used by fire fighters in municipalities, industry, or military training exercises.

This invention was necessary to provide a low cost method to train fire fighters in how to find and extinguish a fire. For safety and environmental reasons, actually setting a fire in a training atmosphere is becoming impractical.

The primary method for locating the seat of a fire inside a structure is to listen for the crackling and popping of the fire itself. Once this is done, a room of origin can be determined.

After a fire fighter enters that room, he/she must spray water onto the seat of the fire. The best way to find the seat of a fire is to look for the glow of the fire, usually red or orange. Spraying water at the seat of the fire then darkens the fire and the popping and crackling cease.

This invention accurately simulates the above conditions without actually placing the fire fighter in danger by exposure to heat and toxic gases. The device can be used in the same structure over and over without damaging the structure.

### BRIEF SUMMARY OF INVENTION

In order to find and extinguish a fire in medium to heavy smoke conditions, a fire fighter must know what to listen and look for.

This invention simulates the flickering red-orange glow of the seat of a fire. The invention also simulates the crackling and popping noises associated with a fire in its incipient stage.

By combining this invention with simulated smoke, it is possible to realistically search for and extinguish this simulated fire.

If desired, the invention includes a feature that stops the light and noise of fire when water has been applied.

### BRIEF DESCRIPTION OF THE DRAWINGS

Due to the infinite design possibilities, a drawing of a working prototype is included. (FIG. A) There are many ways to configure the exact dimensions of the device. There are also many different components that could be used in the device. The drawing provided depicts a very simple version containing readily available components and simple construction.

There is a light source of some sort, be it incandescent, LED, or other lighting, meant to simulate the flickering glow of a fire. The drawing shows incandescent flood bulbs (FIG. A(6)) facing toward the front of the device. The light is caused to flicker by (FIG. A(3)) a round cut sheet of clear plastic mounted on the rotating shaft of a motor (FIG. A(5)). The sheet is painted with stripes to cause a varying amount of light to pass through to the front (FIG. A(7)) sheet of clear plastic.

There is some provision for sound generation, be it a speaker, chains, springs, digital recording, or any other means of sound generation meant to produce the crackling associated with a fire. The drawing shows as the sound generation device a set of chains (FIG. A(2)) mounted to the round cut sheet of clear plastic (FIG. A(3)) mounted on the rotating shaft of a motor (FIG. A(5)). As the motor turns, the chains contact the aluminum sides of the device and produce a popping and crackling noise meant to simulate the sounds of fire. There is a water detection device of some kind, be it a float switch, moisture detector, or some other means or water detection, meant to turn off the device after water is applied to simulate extinguishing of the fire. The drawing shows a float switch (FIG. A(4)) mounted to the side of the box. The water is sealed out of the box by a sheet of clear plastic covering the components (FIG. A(9)). The water collects due to a sheet of clear plastic (FIG. A(7)) forming a front compartment out of these clear plastic sheets that will allow the light from the bulbs (FIG. A(6)) to reach the room.

Handles are cut in the exterior of the device to facilitate transportation of the device (FIG. A(8)).

### DETAILED DESCRIPTION

The invention consists of a waterproof box made from aluminum, plastic, or other corrosion resistant materials. The front of the box should have an opening to allow the light to enter the room from within the box. The opening should be covered with a sheet of clear plastic to seal any water from entering into the box and contacting the internal components.

A light source of red or orange, which raises and lowers in intensity, is located inside the waterproof box. The light source could consist of incandescent lights, LED (light emitting diode) light source, HID (high intensity discharge) lighting, or any other light source. The light should face toward the opening covered with the sheet of plastic. The light should be intense enough to be seen through simulated smoke within the room. The light should vary in intensity to a degree that simulates the flicker of firelight.

A sound generation device that reproduces sound similar to that of a fire should be on the device. The sound may be produce mechanically with springs, chains or other physical means, or may be produced digitally with a sound generation device and speaker, or may be produce by any other means. The sound produced should simulate the sound of a fire crackling at a level intense enough to hear through closed doors to allow a fire fighter to locate the device by listening for this sound.

A water detection device should be mounted outside the sealed compartment of the device. This device could be a float switch, low voltage contacts, or any other water detection device. This is meant to turn the machine off when the fire fighter actually sprays water onto the device. This simulates the fire being extinguished by applying a water stream to the base of a fire.

Power for the device may be a 120 volt AC source or it may be self-contained by battery power.

The invention is designed to be used in conjunction with a fog machine, smoke generator, or other smoke simulation. The invention is placed in a room, the smoke simulator is activated in that room, and the door is closed. A fire fighter then enters the structure or area where the device is located and seeks out the device by listening for the fire noises. Once the room of the invention is found, the fire fighter can simulate extinguishing the fire by actually spraying it with water. The invention stops producing the noise and light, simulating the seat of the fire being extinguished.

I hereby claim the device has the following components together in combination to produce a unique invention.

1) The device is contained in a waterproof corrosion resistant box, containing a water detection component that turns the device off if water is detected.

2) The device accurately simulates the light and sound of an actual fire inside a room or structure without the danger of heat, toxic gases, and structural damage.
